(19) United States
(12) Patent Application Publication
(10) Pub. No.: US 2010/0167881 A1
(43) Pub. Date: Jul. 1, 2010

(54) Crank mechanism and bicycle incorporating same

(76) Inventor: Franklin J. Day, Walnut Creek, CA (US)

Correspondence Address: CHERNOFF, VILHAUER, MCCLUNG & STENZEL, LLP, 601 SW Second Avenue, Suite 1600, PORTLAND, OR, 97204-3157, US

(21) Appl. No.: 12/655,535

(22) Filed: Dec. 31, 2009

Related U.S. Application Data
(60) Provisional application No. 61/204,216, filed on Dec. 31, 2008.

(51) Int. Cl. A63B 22/06; B62M 3/00

(52) U.S. Cl. 482/57; 74/594.1

(57) ABSTRACT

A crank mechanism useful on a bicycle or an exercise machine utilizing a pair of crank arms. A crank arm is attached to a crankshaft so that it can turn the crankshaft in either direction but is free to move through a defined angle about the crankshaft between positions of oppositely driving engagement with the crankshaft. The mechanism can be used in training athletes. In one embodiment the mechanism can be used to aid a bicyclist in maintaining an aerodynamic posture.

### CROSS REFERENCE TO RELATED APPLICATION

This application claims the benefit of U.S. Provisional Patent Application Ser. No. 61/204,216, filed Dec. 31, 2008.

### BACKGROUND OF THE INVENTION

The present disclosure relates to crank mechanisms and more particularly to crank mechanisms useful in bicycle drives and in exercise machines and to use of such mechanisms in racing and in strength and coordination training for athletes.

The present applicant's U.S. Pat. No. 5,860,329 discloses a crank system in which a clutch is associated with each of a pair of pedal cranks. A user's feet must be clipped or otherwise connected to the pedals and the user must pull each pedal up, constantly keeping each crank arm urging the crankshaft forward, in order to keep the pedals from departing from a normal 180 degree crank arm separation angle. Once the crank arms are allowed to move away from the usual 180 degree opposite orientation, regaining the desired relative positions may be awkward and requires a certain amount of skill.

The unidirectional clutches in the arrangement disclosed in U.S. Pat. No. 5,860,329 are somewhat costly, and they do not provide a way for a user to drive the crankshaft in an opposite direction of rotation and, when used during racing they offer the further disadvantage of increasing wind resistance during coasting periods because a bicycle equipped with such a crank mechanism does not provide for coasting with a cyclist's feet in the conventional forward and rearward opposite positions at crankshaft height. When coasting, unless the cyclist actively raises a pedal (the antithesis of resting during coasting) the pedal will go to its lowest position, and the entire length of each of a cyclist's legs will add to frontal area meeting air resistance.

What is desired, then, is a less costly mechanism than has previously been available for connecting a crank arm to a crankshaft in a way that provides the possibility for an appropriate angular relative movement of a crank arm with respect to the crankshaft, in a manner that is useful for teaching cranking in a coordinated, efficient way, is useful in training a user's muscles to drive a crank system more powerfully, and that may provide for restful coasting of a bicycle, with reduced aerodynamic drag, and to allow the rider to apply force when pedaling the bicycle backwards.

### SUMMARY OF THE DISCLOSURE

The crank mechanism disclosed herein provides answers to some of the aforementioned disadvantages and needs. As one aspect of an embodiment of the present mechanism a crank arm is mounted on a crankshaft through an intermediate structure, hereinafter for the sake of convenience called a drive adaptor, which is fixed to the crankshaft, and the crank arm is mounted on the drive adaptor with a selected amount of angular freedom of movement of the crank arm about an axis of rotation of the crankshaft, in other words an amount of relative rotation, relative to the adaptor.

In one embodiment of the apparatus disclosed herein at least two different amounts of angular freedom of motion of the crank arm relative to the drive adaptor are available, and each amount of angular freedom can be selected by temporarily loosening the crank arm from the drive adaptor and moving the crank arm to a required position with respect to the adaptor.

In one embodiment of the mechanism disclosed herein a crank arm is free to move through an angle greater than 180 degrees relative to the drive adaptor, between a normal forward driving position and a rearward driving position, in one position of mounting the crank arm with respect to the drive adaptor.

In a bicycle equipped with one embodiment of the crank mechanism disclosed herein both of a pair of crank arms can be placed in a raised position extending steeply upward so that their respective pedals are both near an uppermost position of rotation, while the crank arms urge the crankshaft in opposite directions, so that the cyclist can rest with both knees raised, to provide a reduced aerodynamic drag (similar to a ski racing tuck) while the bicycle is coasting.

In one embodiment a bicycle may include a foot rest mounted on its seat tube to allow a rider to assume a highly aerodynamic position on the bicycle.

The foregoing and other features of the disclosed subject matter will be more readily understood upon consideration of the following detailed description taken in conjunction with the accompanying drawings.

### BRIEF DESCRIPTION OF THE DRAWINGS

FIG. 1 is an exploded view of a crank assembly and crank system incorporating one embodiment of the mechanism disclosed herein, arranged to drive a chain ring of a bicycle.

FIG. 2 is perspective view of an inner end portion of a crank arm, together with a drive adaptor that can be fastened to a conventional tapered square end of a bicycle crankshaft and that cooperates with the crank arm shown.

FIG. 3 is a perspective view of the portion of a crank arm shown in FIG. 2, with the drive adaptor shown in FIG. 2 in a selected one of several possible positions of engagement with the crank arm.

FIG. 4 is an end elevational view of a drive adaptor that is an alternative embodiment of the one shown in FIGS. 2 and 3.

FIG. 5 is an end elevational view of a drive adaptor that is another alternative embodiment of the one shown in FIGS. 2 and 3.

FIG. 6 is a right side elevational view toward a chain ring adaptor for inclusion in the crank mechanism disclosed herein, in position on a crankshaft of a bicycle, but without a crank arm in place.

FIG. 7 is a composite sectional view taken in the direction indicated by the line 7-7 in FIG. 3, showing the manner in which one embodiment of the crank mechanism shown in FIGS. 1-3 is fastened together.

FIG. 8 is a right side elevational view of bicycle, showing positions of the crank arms during use of the crank mechanism in normal forward pedaling.

FIG. 9 is a view similar to FIG. 8 showing possible crank arm positions during coasting with the crank drive adaptors assembled to provide one selected amount of crank arm freedom.

FIG. 10 is a view similar to FIG. 9 showing a bicycle rider in a highly aerodynamic coasting position available with one of the drive adaptors arranged to provide a large angle of crank arm freedom of rotation with respect to the crankshaft.

FIG. 11 is a right side perspective view of a portion of a bicycle including a foot rest.

FIG. 12 is a right side perspective view of a bicycle and a rider with raised knees.

FIG. 13 is an end elevational view of a drive adaptor similar to the one shown in FIG. 4, equipped with inserts to reduce the size of one of the slots.

FIG. 14 is a sectional view taken on line 14-14 of FIG. 13.

FIG. 15 is an end elevational view of a drive adaptor that is an alternative embodiment of the one shown in FIGS. 13 and 14.

FIG. 16 is a perspective view of an adjustment insert in the form of a pin, for use in the drive adaptor shown in FIG. 15.

### DETAILED DESCRIPTION OF EMBODIMENTS

Referring now to the drawings which form a part of the disclosure herein, a crank mechanism 12 is shown in an exploded perspective view, together with part of a seat tube 14 of a conventional bicycle frame and a bottom bracket 16 in which a conventional crankshaft 17 is supported in suitable bearings for rotation about an axis of rotation 18. The crankshaft 17 shown herein has conventional tapered square ends 20 and 22 as used to receive and be driven by a pair of crank arms in a conventional bicycle.

In the crank mechanism 12 as shown here, a drive adaptor 24 defines a square hole 26 that fits on the square end 20 of the crankshaft 17, and a bolt 28 extends through the drive adaptor 24 into a threaded bore within the square end 20 to fasten the drive adaptor 24 to the square end 20 in a manner similar to that used to attach a conventional bicycle pedal crank arm to a crankshaft.

Similarly, a drive adaptor 30 that includes a chain ring receiving flange 32 defines a centrally located square hole 34, and a bolt 36 extends through the square hole 34 to attach the drive adaptor 30 to the square end 22 of the crankshaft 17.

Thus the crank mechanism 12 can be used on a conventional bicycle with no modification except replacement of the conventional crank arms and chain ring adaptor. It will be understood that suitable adaptors similar to the adaptors 24 and 30 might be provided to fit other types of available crankshafts such as those having splined ends of various commercially available configurations, and crankshafts and suitable adaptors may be provided to replace chain ring drive adaptors combined with crankshafts in some commercially available bicycle bottom brackets.

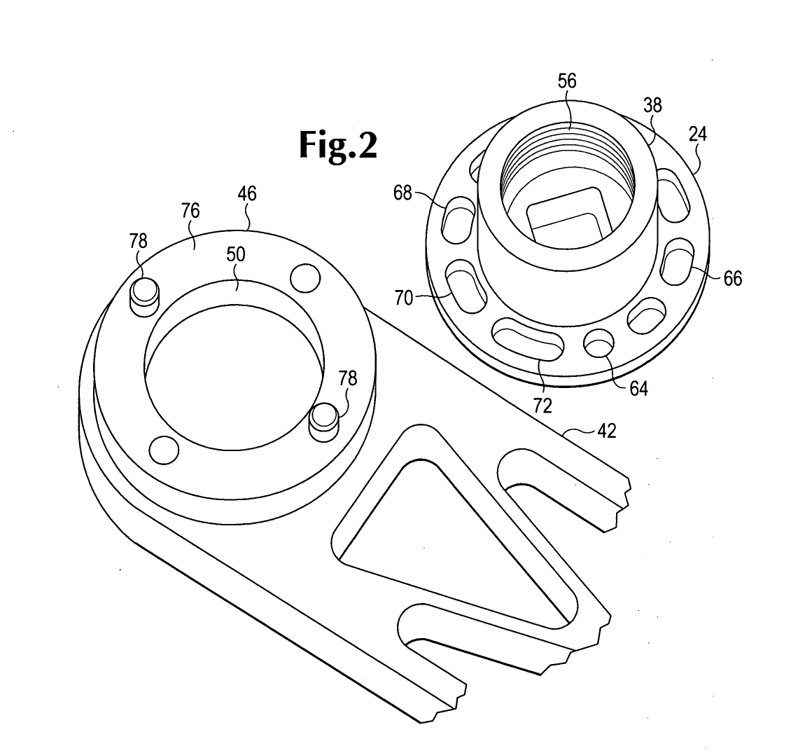

The drive adaptors 24 and 30 include respective journals 38 and 40 concentric with the axis of rotation 18. A pair of crank arms, a left crank arm 42 and a right crank arm 44, each include a respective hub 46, 48, each of which defines a bearing 50 of an appropriate size to receive the respective journal 38 or 40. The hub 46 is attached to the drive adaptor 24 by an end cap 52 that is fastened to the drive adaptor 24, as by threads 54 on the end cap that mate with threads 56 defined within the drive adaptor 24, as may be seen in FIG. 2 and as will be explained in greater detail below.

Similarly, the hub 48 fits over the journal 40 of the drive adaptor 30 and is held in place by an end cap 58 that is fastened similarly to the drive adaptor 30. It will be clear that the end caps 52 and 58 might be fastened to the drive adaptors 24 and 30 in other ways, such as by the use of screws or appropriate bayonet joints, etc. (not shown), so long as they are attached securely enough to prevent the hubs 46 and 48 from moving axially outward on the journals 38 and 40 of the drive adaptors 24 and 30. It will also be understood that a different bearing arrangement might be used to allow the crank arm 42 or 44 to revolve about the adaptor 24 or 30.

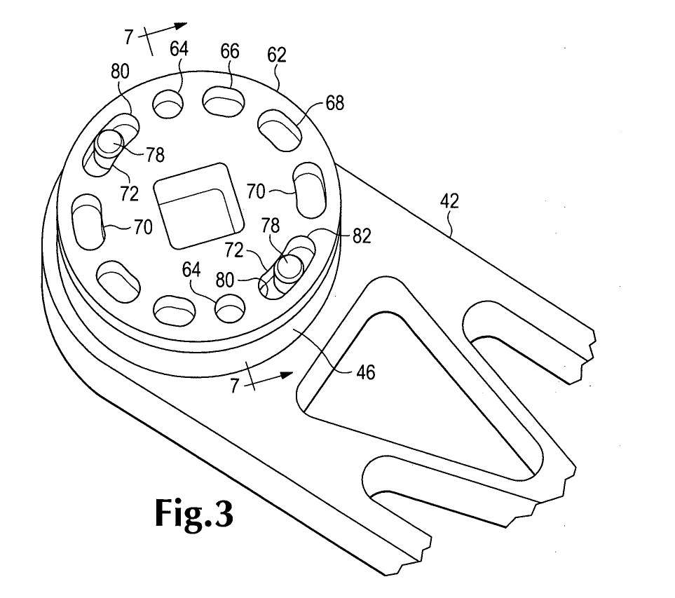

Referring next to FIGS. 2 and 3, the adaptor 24, the hub 46, and a portion of the crank arm 42 are shown in perspective view, where it may be seen that the drive adaptor 24 includes a radially extending flange 62 defining pairs of oppositely located arcuate slots 64, 66, 68, and 70 extending along an imaginary circle on the flange 62, concentric with the axis of rotation 18. The slots as shown extend through the flange 62, but, as will be understood presently they need not extend entirely through the flange 62, so long as they are open on the side of the flange 62 facing toward the hub 46 and shown uppermost in FIG. 2.

The laterally inboard side of the hub 46 includes a flat face 76 extending radially outward about the bearing 50, and a force-transmitting or driving interconnection in the form of a driving projection, such as a pair of drive lugs 78 in the form of cylindrical pins, protrudes from the face 76 in position to extend into and engage respective ones of the slots 64, 66, 68, 70, or 72 when the hub 46 is fitted onto the journal 38, as shown in FIG. 3.

As may be seen best in FIG. 3, the slots 64, etc. are of several different sizes. In the drive adaptor 24 as shown in FIGS. 2 and 3, the relative sizes of the slots 64, etc., and the drive lugs 78 are chosen such that for the slots 64 the drive lugs 78 fit snugly, preventing the hub 46, and thus the crank arm 42, from rotating with respect to the drive adaptor 24.

Because of the graduated set of different sizes of the pairs of opposed slots 66, 68, 70, and 72, varying amounts of freedom of rotation of the hub 46 and crank arm 42 are available depending upon the relative positions of the hub and the drive adaptor. Thus various angles of freedom of rotation of the crank arm 42 about the drive adaptor 24 and the crankshaft 17, such as 2, 5, 10, and 25 degrees of angular freedom of movement may be provided, respectively, by the slots 66, 68, 70, and 72.

It will be understood that drive lugs 78 such as the drive pins shown may be placed on and extend from the flange 62 toward the hub 46, and the slots 64, 66, 68, 70 and 72 could be formed into the flat inner face 76 of the hub 46. It will also be understood that the slots and drive lugs, if provided as pairs, need not be spaced apart by 180 degrees, but could be designed for other angular placement.

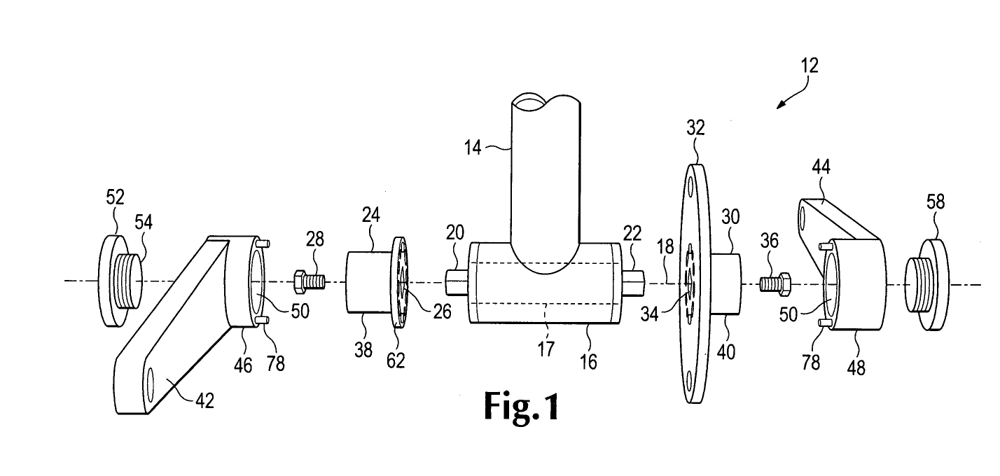

With the drive lugs 78 engaged in the slots 72 as shown in FIG. 3, when the crank arm 42 is moved in a first direction, as by pedaling forward on a bicycle including the crank mechanism 12 shown in FIG. 1, the drive lug 78 will engage a forward drive engagement surface 80 of the slot 72, urging the drive adaptor 24 to rotate in a forward direction, and with the drive adaptor 24 mounted on the square end 20 of the crankshaft 17, the crank arm 42 will thus cause the crankshaft 17 to rotate forward. When the crank arm 42 is moved in the opposite direction about the axis of rotation 18 the drive lug 78 is brought to bear on a rearward drive engagement surface 82 of the slot 72, urging the drive adaptor 24, and thus the crankshaft 17, to rotate in the opposite, or rearward, direction.

While the drive lug 78 is shown as a pin which may be fitted in an appropriate bore defined in the hub, it will be understood that the drive lug could be of another shape and could be provided by machining the material of the crank arm and hub, or the drive lug might be fastened to the hub in a different manner, and the drive engagement faces 80 and 82 at the ends of the slots could be shaped as required to conform to the shape of the drive lug.

The drive adaptor 30 may similarly be provided with slots 64, 66, 68, 70, and 72 correspondingly located so that when both the crank arms 42 and 44 are driven in the same forward direction the crank arms 42 and 44 will extend oppositely, 180 degrees apart from each other with respect to the axis of rotation 18. It will be understood, then, that for such an opposite orientation of the crank arms 42 and 44, the slots 64, etc., in the drive adaptor 30 must be located in an arrangement that is a mirror-opposite from that of the drive adaptor 24, and the drive adaptors 24 and 30 must be installed on the square ends 20 and 22 in correctly indexed positions. Thus when the hubs 46 and 48 are placed respectively on the journals 38 and 40 with the respective drive lugs 78 fitted into the slots 64, 66, etc., of like size, the crank arms 56 and 60 will extend oppositely away from the crankshaft 17 when both are being urged to revolve in the same direction about the axis of rotation 18, either forward or rearward.

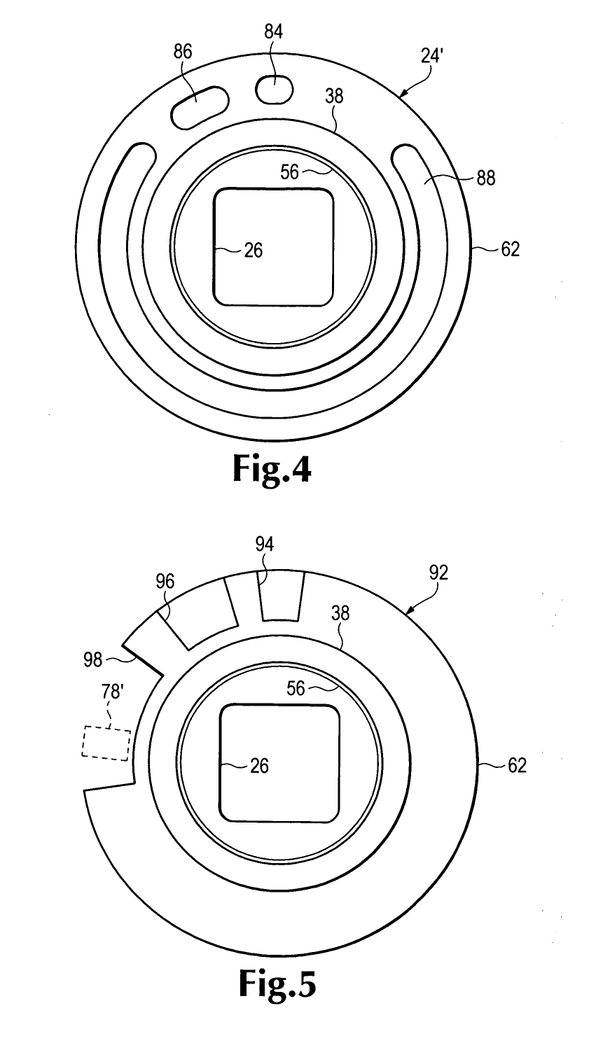

As shown in FIG. 4, a drive adaptor 24′ may include a set of arcuate slots of other sizes. For example, a slot 84 may provide freedom of movement through an angle of 2 degrees, a slot 86 may provide an angle of 15 degrees of freedom of movement, and a slot 88 may provide freedom of movement of a lug 78 through an angle of 240 degrees rotation of a crank arm with respect to a crankshaft. The drive adaptor 24′ shown is similar to the drive adaptor 24 shown in FIGS. 1-3 for use on the end of a crankshaft 17 without a chain ring receiving flange, but it will be appreciated that an equivalent group of slots might be provided in a drive adaptor including a flange extending radially to receive one or more chain rings, similar to the drive adaptor 30 shown in FIG. 1, as may be seen in FIG. 6. Since the slots shown in FIG. 4 are not arranged in pairs of opposed similar slots, the mating crank arm hub must have only a single drive lug 78; however, as a result, a crank arm 42 or 44 may have a larger angle of freedom of motion with respect to a drive adaptor 24′ including such an arrangement of slots. Again, it will be appreciated that the slots 84, etc., could be defined in the radially-extending flat face 76 of a hub 46 or 48 of a crank arm, with the drive lug 78 being provided on the flange 62 of the drive adaptor 24′.

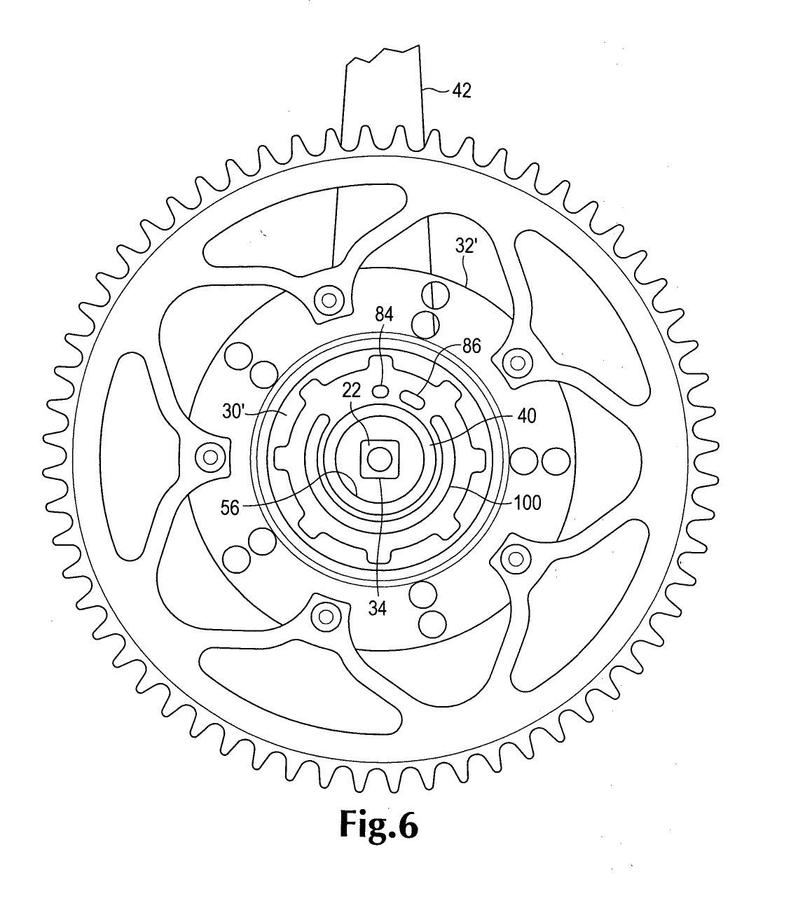

As shown in FIG. 5, rather than arcuate slots 64, etc., such as those shown in FIGS. 2-4, a drive adaptor 42 similar to the drive adaptor 24 may be provided with notches 94, 96, and 98 extending radially inward from the circumference of the flange 62, and a drive lug 78′ may have an angular shape (shown in phantom) and project laterally, or axially, parallel with the axis of rotation 18, from the hub 46 or 48 of the crank arm, to fit in a selected one of the notches 94, etc., in the drive adaptor. The notches 94, etc., may extend only a part of the way through the flange 62, as shown in notches 94 and 96, or may extend completely through the thickness of the flange 62, as shown in the notch 98. This type of driving interconnection between a crank arm and an adaptor could also be arranged oppositely, with the notches on the hub of the crank arm and the drive lug located on the flange of the drive adaptor in position to fit within a selected one of the notches.

As shown in FIGS. 4 and 6, a slot in a drive adaptor, such as the slot 88, may subtend an angle greater than 180 degrees. A drive adaptor 30′, shown in FIG. 6 includes drive slots 84 and 86 similar in size and corresponding in placement to the slots 84 and 86 in the drive adaptor 24′ shown in FIG. 4. A slot 100, however, is shown as being of a size to afford angular freedom of movement of a crank arm 44 through an angle of about 225 degrees, leaving ample material around the slots to provide support for the chain ring supporting flange 32′.

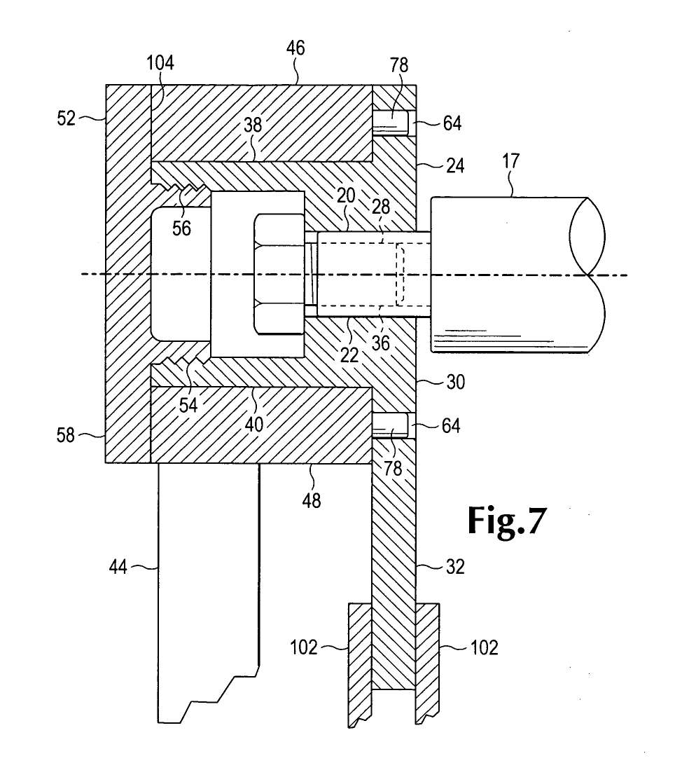

FIG. 7 shows components of the crank mechanism 12 assembled. In the upper part of FIG. 7, the drive adaptor 24 is represented, while in the lower portion of the figure the drive adaptor 30 is shown, with its included flange 32 carrying a pair of chain rings 102. As may be seen in FIG. 7, the bolt 28 or 36 may be mated in a threaded bore in the end of the crankshaft 17 and may be tightened to hold the drive adaptor 24 or 30 tightly engaged with the square end 20 or 22 of the crankshaft 17. The end cap 52 or 58 is mated tightly with the drive adaptor, leaving sufficient axial space between the hub 46 or 48 and the radially extending inner surface 104 of the end cap 52 or 58, and it may be seen that the drive lug 78 extends into the drive slot 64.

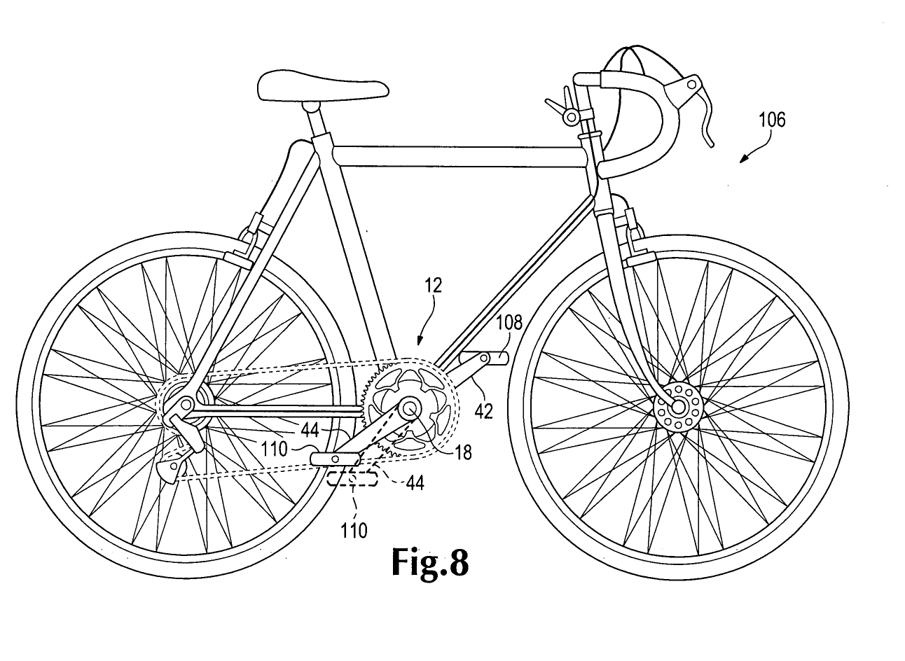

As shown in FIG. 8, as a bicycle 106 equipped with a crank mechanism 12 such as that shown in FIGS. 1-3 is pedaled the crank arms 42 and 44 may extend in conventionally opposite locations, separated by an angle of 180 degrees about the axis of rotation 18 of the crankshaft and the chain rings 102 mounted on the drive adaptor 30, so long as the pedals 108, 110 attached to the crank arms 42 or 44 are pulled upward by a bicycle rider's feet during the upward part of each revolution. However, if the rider does not continuously urge both pedals 108 and 110 forward, and thus pull up on the pedal 108 or 110 attached to each crank arm 42 or 44 on each up-stroke the crank arm 42 or 44 may lag behind the other one of the crank arms 42 or 44. Thus the crank arm 44 might fall behind, to the position shown in broken line in FIG. 8, for example, depending upon the angular amount of freedom provided by the slot 68, e.g., in which the drive lug 78 of the crank arm hub 48 is engaged.

With continued rotation, so that the crank arm 44 goes through top dead center and the rider begins to press it downward, the crank arm 42 will be in a rearward-extending rising position in which it then must be pulled upward by the rider's left foot, attached to the pedal 108 on the crank arm 42, to keep the crank arm 42 from lagging. Thus as each crank arm proceeds upward toward the top dead center position and continues forward to begin a downward movement, if it has not constantly been urged in a forward direction of rotation of the crankshaft 17, there will be a relatively rapid forward and downward movement to take up lost motion as the crank arm passes through top dead center. This will make an audible noise as the drive lug 78 moves forward within the slot to lodge against the forward drive engagement surface 80 of the slot, announcing to the rider that the rider has not successfully maintained forward pressure at all times through the entire revolution of the pedal and crank arm.

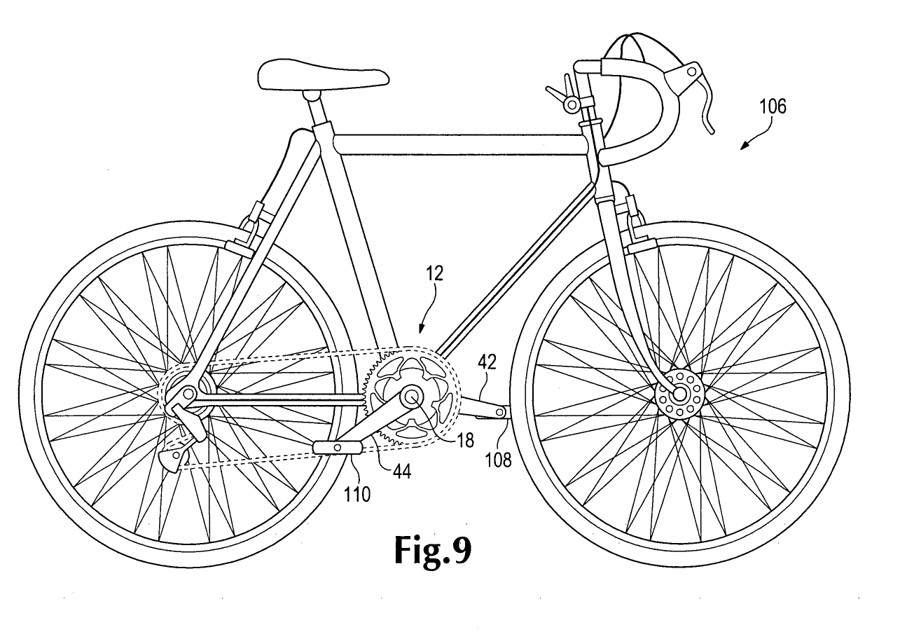

Referring next to FIG. 9 it may be seen that the two crank arms 42 and 44 are both in a slightly downwardly sloping orientation, with both of the pedals 108 and 110 located lower than the axis of rotation 18 of the crankshaft 17. The crank arms 42 and 44 are thus located at an angle different from the 180 degree crank arm separation of a conventional bicycle crank, with the resulting slopes of the crank arms 42 and 44 determined by the amount of angular freedom of motion provided by the drive slot in which the respective drive lug 78 for each pedal is located. For example, when the slot 68 provides an angular freedom of motion of 30 degrees, the pedals 42 and 44 would be separated by an angle of 150 degrees, with each crank arm 42 and 44 sloping at a downward angle of 15 degrees when the pedals are at equal heights. The lug 78 on the hub 48 of the crank arm 44 is thus engaged with the rearward drive engagement surface 82, while the lug 78 on the hub 46 of the crank arm 42 is engaged against the forward drive engagement surface 80 of the respective slot.

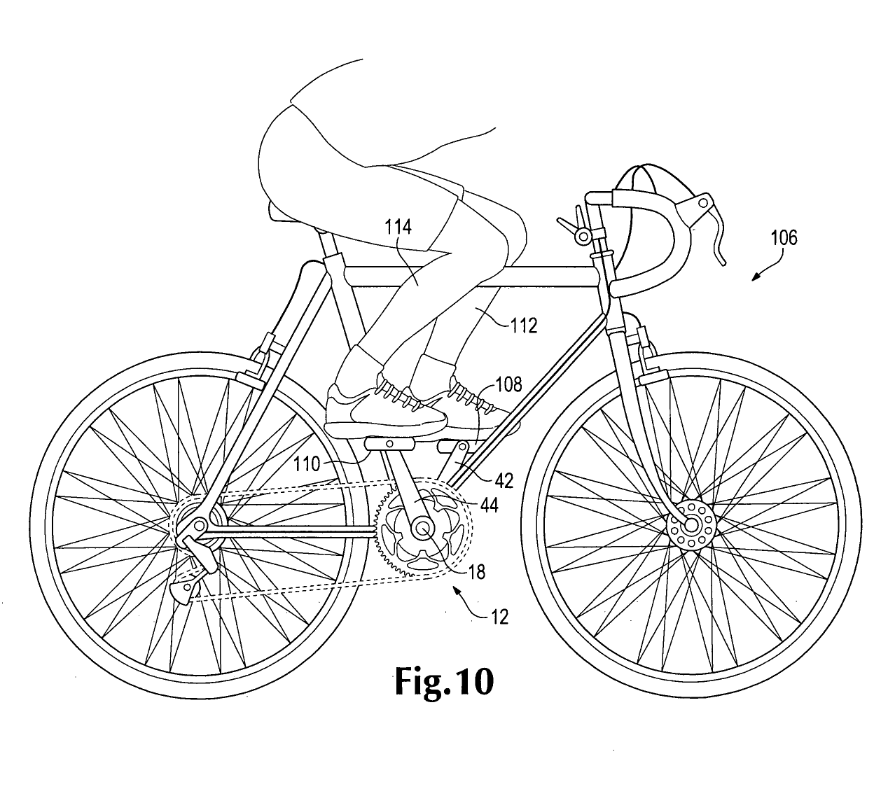

As shown in FIG. 10, when the drive lug associated with the right crank arm 44 is engaged in the slot 100 shown in FIG. 6, which gives freedom of motion through an angle of 225 degrees, and when the left crank arm 42 extends upward above the axis of rotation 18, inclined slightly forward, the right crank arm 44 can be rotated rearwardly to engage the lug 78 with the rearward drive engagement surface 82 of the slot, bringing the crank arm 44 to the upwardly directed rearwardly-inclined position shown in FIG. 10, so that the rider's feet are both supported at a position near the top of the rotation of the crank arms 42 and 44, with the crank arms 42 and 44 respectively urging the crankshaft 17 to rotate in opposite directions. The rider's legs 112 and 114 are then tucked close to the body and present a significantly smaller frontal area during coasting than when the crank arms 42 and 44 are in a conventional 180 degree separation, and are significantly more aerodynamic than when the crank arms 42 and 44 are in the downwardly sloping positions shown in FIG. 9.

While each of the drive adaptors 24 and 30 might be provided with a respective slot or notch subtending a large angle, such as the 240 degrees angle of the slot 88, it is sufficient if only one of the drive adaptors has such a large angle of freedom of motion to provide the availability of a position of the crank arms in which they are in balanced opposition and both extend slopingly upward to a position such as that shown in FIG. 10. Since having such a large angle slot or notch of greater than 180 degrees of rotational freedom in only one of the drive adaptors would require that the same foot be in the forward position each time it is desired, having a slot or notch defining a large angle of freedom of rotational motion in each drive adaptor gives the user a choice of which foot to hold forward. The slightly larger 240 degree freedom of motion provided by the slot 88 of the drive adaptor 24′ shown in FIG. 4 provides a 60 degree angle between the crank arms 42 and 44, when the crank arm 42 is rearward, giving a slightly more stable position for the rider, with a small cost in additional aerodynamic drag as compared with the smaller angle shown in FIG. 10.

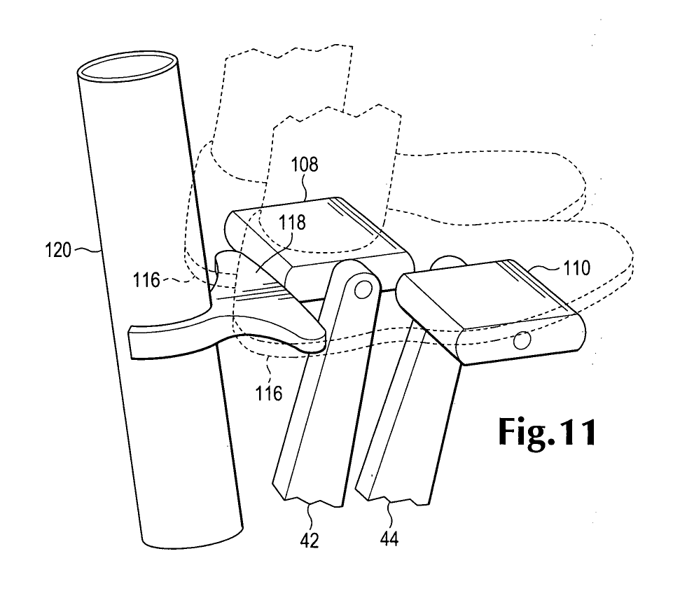

Referring to FIGS. 11 and 12, as further ways to provide a highly aerodynamic position, a rider may rest his heels 116 on a shelf 118 that may be attached by brazing, a clamp, or other suitable means to the seat tube 120, as shown in FIG. 11, releasing his feet from the pedals 108 and 110, if necessary because of the available freedom of rotational motion of a crank arm being too small. Alternatively, the rider may release his feet from the pedals and utilize a pair of fasteners such as a leg bands 120 of hook-and-loop fastening material engaged with corresponding hook-and-loop material 122 mounted on the top tube of the bicycle 106 to aid in suspending the rider's legs 112, 114 with the feet raised as high as practical, as shown in FIG. 12.

Provision of several different slots providing different amounts of angular freedom of motion of the respective crank arms gives a user, such as a bicycle rider, the option to select a very small angle of freedom of motion, such as about 2 degrees, so that riding a bicycle equipped with the crank mechanism 12 will not be too difficult, yet the take-up of lost motion at the top of the revolution of a crank arm will provide audible feedback to the cyclist who is attempting to learn to ride with constant forward pressure on both crank arms 42 and 44. Use of a larger angle of freedom of motion may provide better training by removing the tempting option of allowing the downward moving crank arm to raise the upward-moving crank arm.

The largest angle of freedom of motion, greater than 180 degrees, and as much as, for example, 225 or 240 degrees of freedom of movement, can be advantageous for use of the crank mechanism 12 in a bicycle to provide a highly aerodynamic pedal position for coasting, as explained above.

Freedom of motion of each pedal crank arm 42 and 44 through an intermediate-sized angle of, for example, 25 degrees, can be very useful in exercise machines that might be used by athletes desiring to move a crankshaft 17 alternatingly both in a forward direction and in a rearward direction with coordinated use of the crank arms in both directions.

Accordingly, the crank mechanism 12 can be adjusted easily to engage the drive lug 78 with any selected one of the slots or notches of the respective drive adaptor 24 or 30 by loosening or removing the respective end cap 52 or 58 from the respective drive adaptor 24 or 30. The hub 46 or 48 can then be moved axially outward along the journal 38 or 40 far enough to disengage the drive lug 78 from one slot or notch and engage it into one providing the desired angular freedom of motion with respect to the drive adaptor 24 or 30. The end caps 52 and 58 may then be replaced and retightened with the drive lug 78 engaged in the desired slot or notch in each drive adaptor.

While the crank mechanism 12 has been described above primarily with respect to use in a bicycle, it will be understood that the crank mechanism could also be used in a stationary exercise machine in which the crank arms may be driven by pedals or by hand. While a principal benefit from use of the crank mechanism 12 in most instances will be the use in training an athlete to provide force in a coordinated manner through an entire revolution of each crank arm, another utility is to train the muscles of a user's leg or arm to provide torque in either selected direction and throughout an entire revolution of a crank arm. Therefore, while the crank mechanism 12 has been disclosed in connection with a crank shaft having a drive adaptor at each end, the mechanism disclosed may be used on a crankshaft to drive only one end of the shaft.

In another application, the crank mechanism may be used for a pair of crank arms each driving a separate one of a pair of coaxial shafts extending either toward or away form each other, or to drive a pair of concentric shafts of which one is tubular and the two shafts are rotatable with respect to each other.

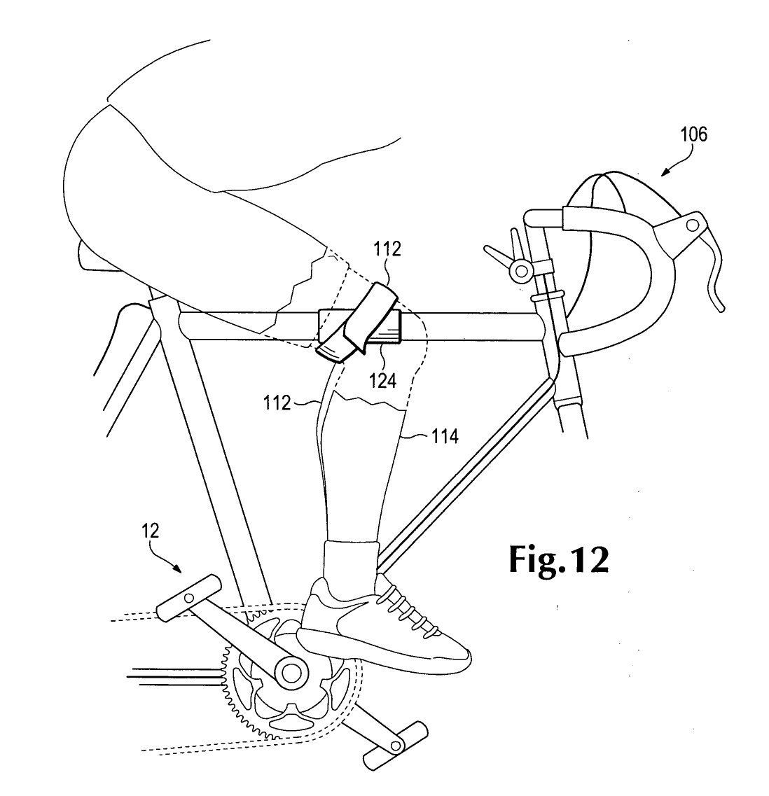

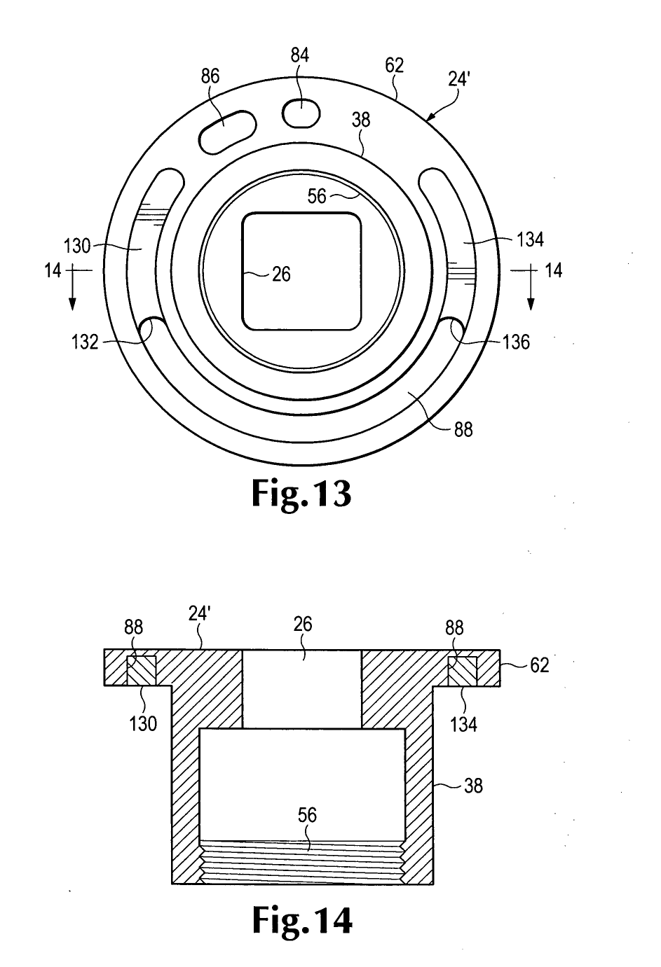

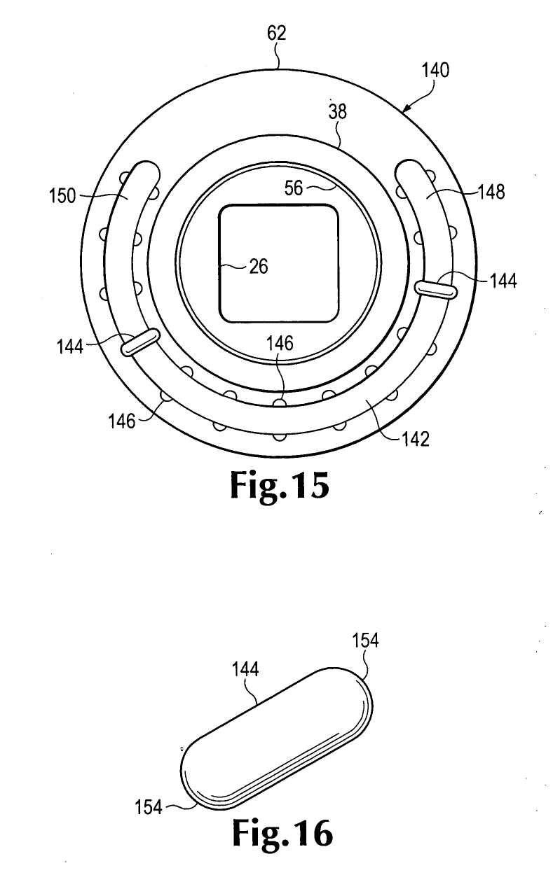

As shown in FIGS. 13 and 14, as a further way to adjust the amount of angular freedom of movement of a crank arm such as the crank arm 42 with respect to the drive adaptor 24′, an adjustment insert 130 is shown in place in one end of the 240 degree slot 88. The insert 130 has a drive engagement surface 132 of an appropriate shape to be engaged by a drive lug such as the drive lug 78. As shown, the insert 130 reduces the angular size of the slot 88 by an angle of about 80 degrees, although it will be understood that the angular size of the insert 130 may be greater or smaller as desired.

A second adjustment insert 134 is shown installed in the opposite end of the slot 88 and has a drive engagement surface 136. With both the insert 130 and the insert 134 in place, the angular freedom of movement of the crank arm 42 with respect to the drive adaptor 24′ is even further reduced. Thus by use of inserts 130 and 134 of different angular sizes, and by use of one, the other, or both of a pair of inserts 130 and 134 a choice of several ranges of freedom of angular movement of a crank arm 42 can be provided. Thus, if desired, a suitable set of inserts 130 and 134 may be used in a slot 88 and other slots such as the slots 84 and 86 need not be provided. It will be understood that the same arrangement of adjustment inserts 130 and 134 in mirror opposite locations may be used in a chain-side drive adaptor 30′.

The inserts 130 and 134 may be installed by a procedure similar to that of selection of a desired one of several slots 84, 86, or 88, where the slot 88, as shown in FIG. 14, does not extend entirely through the flange 62 of the drive adaptor 24′. That is, referring to FIG. 7, an end cap 52 can be loosened or removed, allowing a crank arm hub 46 to be moved outwardly along the journal 38 far enough to allow an insert 130 or 134 to be placed into the slot 88, where it is retained once the end cap 52 is refastened in place on the drive adaptor 24′.

Another embodiment of the crank mechanism drive adaptor 140 is shown in FIG. 16. The flange 62 of the drive adaptor 140 defines a slot 142 extending along an arc of, for example, about 240 degrees to allow freedom of angular movement of a related crank arm 42 whose hub 46 carries a drive lug 78 engaged movably in the slot 142. An adjustment insert 144 may be fitted to the drive adaptor 140 to limit the angular freedom of motion of the crank arm 42 with respect to the drive adaptor 140. As shown here, the adjustment insert 144 may be a pin, shown enlarged in FIG. 16. Opposite ends 154 of the insert 144 may be seated in correspondingly shaped seats 146 on radially opposite sides of the slot 142, so that a central part of the insert 144 spans the slot to obstruct the drive lug 78 at a selected position along the slot 142. The insert thus limits movement of the crank arm 42 by limiting movement of the drive lug 78 along the arc of the slot 142, either in an end portion 148 or 150, between an end of the slot 142 and an insert 144, or between consecutive inserts 144, if two inserts 144 are placed into respective pairs of seats 146.

While the exact shape of an insert 144 is not critical, and various shapes would be possible, a generally cylindrical pin as shown in FIG. 16, with rounded, perhaps hemispherical, ends 154, may facilitate forming correspondingly shaped seats 146 in the flange 62 of the drive adaptor 140 by use of conventional machine tools.

Installation of the drive inserts 144 into the seats 146 can be performed in a manner similar to installation of the inserts 130 and 134 described above. A corresponding drive adaptor (not shown) for use with a chain ring may be made to accept drive adjustment inserts 144 in the same manner.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. A crank assembly, comprising:
(a) a crankshaft having a driven end and an axis of rotation;
(b) a drive adaptor mounted drivingly on the driven end;
(c) a crank arm mounted on the drive adaptor and rotatable with respect to the drive adaptor about the axis of rotation of the crankshaft; and
(d) a driving interconnection between the crank arm and the drive adaptor defining a non-zero amount of angular freedom of rotational motion of the crank arm with respect to the drive adaptor and limiting rotation of the crank arm with respect to the drive adaptor to a predetermined angular distance.

2. The crank assembly of claim 1 wherein the crank arm includes a driving projection and the drive adaptor includes a pair of drive engagement surfaces spaced apart from each other by a predetermined angle and located so that a respective one of the engagement surfaces is engaged by the driving projection as the crank arm is rotated with respect to the drive adaptor in each of a pair of opposite directions.

3. The crank assembly of claim 2 wherein the crank arm includes a hub portion and the driving projection is a lug extending axially from the hub portion toward the drive adaptor.

4. The drive adaptor of claim 3 wherein the hub portion includes an inner face and the drive adaptor includes a radially extending flange located adjacent the inner face of the hub portion, and wherein the flange defines an opening receiving the lug, the opening having a pair of opposite ends each including one of the drive engagement surfaces, the lug and opening thereby defining the predetermined angular distance.

5. The crank mechanism of claim 2 wherein the drive adaptor defines a plurality of slots of different angular sizes, each of said slots defining a respective pair of said drive engagement surfaces spaced apart from each other by a respective predetermined angle.

6. The crank assembly of claim 5 including an insert fitted in one of said slots, the insert including a drive engagement surface providing a modified angular distance through which the driving projection can move as the crank arm rotates with respect to the drive adaptor.

7. The crank mechanism of claim 2 wherein the drive adaptor defines a plurality of notches of different angular sizes, each of said notches defining a pair of said drive engagement surfaces spaced apart from each other by a respective predetermined angle.

8. The crank assembly of claim 1 wherein the crankshaft has an opposed second driven end and a second drive adaptor mounted on said second driven end, said drive adaptor and said second drive adaptor each including a plurality of slots of different angular sizes, each said slot including a respective drive engagement surface, a second crank arm being mounted on said second drive adaptor, and said crank assembly including a second said driving interconnection defining a non-zero amount of angular freedom of rotational motion of the second crank arm with respect to the second drive adaptor and limiting rotation of said second crank arm with respect to the second drive adaptor to a second predetermined angular distance, and wherein as part of said driving interconnection said crank arm includes a driving projection and as part of said second driving interconnection said second crank arm includes a second driving projection, said driving interconnections being located to cause said crank arms to extend radially from said axis of rotation aligned 180 degrees apart from each other when each of said driving projections is engaged with a respective one of said drive engagement surfaces.

9. The crank mechanism of claim 3 wherein the hub portion includes a pair of lugs spaced apart from each other by a predetermined angle about said axis of rotation, and wherein the drive adaptor flange includes a pair of similar slots, the similar slots being spaced apart from each other by said predetermined angle.

10. The crank assembly of claim 2 wherein the predetermined angle by which the pair of drive engagement surfaces are spaced apart from each other about the axis of rotation is greater than 180 degrees.

11. A method of exercising, comprising:
(a) providing a crank assembly including a rotary member and a pair of crank arms, each of said pair of crank arms being attached to the rotary member and each of the pair of crank arms being free to move through a predetermined range of angular distance with respect to the rotary member between respective forward and rearward drive engagement angular positions with respect to the rotary member;
(b) arranging each one of said pair of crank arms to drive the rotary member in a forward direction when the respective crank arm is in a first forward drive engagement angular position with respect to the rotary member and to drive the rotary member in a rearward angular direction when the respective crank arm is in a second rearward drive engagement angular position with respect to the rotary member;
(c) driving the rotary member in a selected direction by moving each one of the pair of crank arms to a respective drive engagement angular position with respect to the rotary member.

12. The method of claim 11 wherein the respective forward drive engagement positions for the crank arms are separated by a predetermined angle.

13. The method of claim 12 wherein the predetermined angle is 180 degrees.

14. The method of claim 11 including the step of attempting to keep both crank arms in their respective forward drive engagement angular positions while driving the rotary member forward.

15. The method of claim 11 including the step of sensing departure of one of said pair of crank arms from the selected drive engagement angular position and thereafter moving said one of said pair of crank arms to return said one of said pair of crank arms to said selected drive engagement angular position while continuing to drive said rotary member in said selected direction of rotation.

16. The method of claim 11 including the step of selecting an amount of angular freedom of motion of one of said pair of crank arms relative to said rotary member and placing a drive lug into a corresponding position of driving interconnection between said one of said pair crank arms and said rotary member.

17. A crank assembly, comprising:
(a) a crankshaft having a pair of opposite ends and an axis of rotation;
(b) a drive adaptor mounted drivingly on a first of said opposite ends;
(c) a second drive adaptor mounted drivingly on a second one of said opposite ends;
(d) a pair of crank arms, each one of said pair of crank arms being mounted on a respective one of said drive adaptors and being rotatable about said axis of rotation with respect to said respective one of said drive adaptors;
(e) each one of said pair of crank arms being connected drivingly with the respective one of said drive adaptors, and at least one of said pair of crank arms being connected with the respective one of said drive adaptors so as to be able to drive said drive adaptor in either a first direction of rotation or an opposite direction of rotation, said at least one of said pair of crank arms being free to move through a predetermined non-zero angle of rotation about said respective drive adaptor between a position of engagement therewith for driving in said first direction and a second position of engagement therewith for driving said respective drive adaptor in said opposite direction of rotation.

18. The crank assembly of claim 17 wherein said at least one of said pair of crank arms is drivingly interconnected with said respective drive adaptor so as to transmit a torque to said respective drive adaptor in a first angular direction about said axis of rotation at a first angular position of said crank arm with respect to said drive adaptor, and to transmit torque to said drive adaptor in said opposite angular direction at a second angular position of said crank arm, separated from said first angular position by a predetermined angle of freedom of movement.
